(19) United States
(12) Patent Application Publication
(10) Pub. No.: US 2024/0255725 A1
(43) Pub. Date: Aug. 1, 2024

(54) DRIVING MECHANISM AND DRIVING MODULE

(71) Applicant: TDK TAIWAN CORP., Taoyuan City (CN)

(72) Inventors: Pai-Jui CHENG, Taoyuan City (TW); Shu-Shan CHEN, Taoyuan City (TW)

(21) Appl. No.: 18/191,577

(22) Filed: Mar. 28, 2023

(30) Foreign Application Priority Data
Jan. 31, 2023 (CN) 202320143818.3

(51) Int. Cl. G02B 7/04

(52) U.S. Cl. CPC G02B 7/04

(57) ABSTRACT

A driving mechanism is provided. The driving mechanism includes a fixed assembly, a movable part, and a driving module. The movable part is movable relative to the fixed assembly. The driving module is configured to drive the movable part to move relative to the fixed assembly. When viewed along the first axis, the driving module is disposed between the fixed assembly and the movable part.

### CROSS REFERENCE TO RELATED APPLICATIONS

This application claims the benefit of China. Application No. 202320143818.3, filed on Jan. 31, 2023, the entirety of which is incorporated by reference herein.

### BACKGROUND OF THE INVENTION

### Field of the Invention

The present disclosure relates to a driving mechanism, and in particular it relates to a driving mechanism with a piezoelectric element.

### Description of the Related Art

As technology has developed, many of today's electronic devices (such as smartphones or digital cameras) have components such as motors to drive lenses or other objects. However, the displacement accuracy of conventional motors, such as stepper motors and voice coil motors, do not meet certain specific requirements.

Therefore, how to design a driving mechanism that can improve displacement accuracy and achieve miniaturization are topics nowadays that need to be discussed and solved.

### BRIEF SUMMARY OF THE INVENTION

According to some embodiments of the disclosure, the present disclosure provides a driving mechanism including a fixed assembly, a movable part, and a driving module. The movable part is movable relative to the fixed assembly. The driving module is configured to drive the movable part to move relative to the fixed assembly. When viewed along a first axis, the driving module is disposed between the fixed assembly and the movable part.

According to some embodiments, the fixed assembly includes a base. The driving mechanism further includes a guiding assembly. The guiding assembly is configured to guide the movable part to move along the first axis relative to the fixed assembly. The driving module is connected to the base. The guiding assembly includes a first guiding member and a second guiding member. The first guiding member is fixedly connected to the movable part. The second guiding member is fixedly connected to the base. The driving module is configured to drive the first guiding member to move relative to the second guiding member, so as to drive the movable part to move along the first axis.

According to some embodiments, when viewed along a second axis, the second guiding member, the first guiding member and the driving module are arranged in sequence along a third axis. The second axis is perpendicular to the first axis. The third axis is perpendicular to the second axis and the first axis.

According to some embodiments, the base includes a main body and a connecting block. The main body forms an accommodating opening configured to accommodate the connecting block. The base further includes a first cantilever and a second cantilever. The connecting block is connected to the main body via the first cantilever and the second cantilever. When viewed along the second axis, the first cantilever is connected between a first inner side surface of the main body and the connecting block. When viewed along the second axis, the second cantilever is connected between a second inner side surface of the main body and the connecting block.

According to some embodiments, the driving module includes a first elastic member fixedly installed on the connecting block. When the first elastic member is affixed to the connecting block, the shortest distance between the connecting block and the first inner side surface is different from the shortest distance between the connecting block and the second inner side surface.

According to some embodiments, when the first elastic member is affixed to the connecting block, the shortest distance between the connecting block and the first inner side surface is less than the shortest distance between the connecting block and the second inner side surface. The first cantilever applies a first preload to the connecting block. The second cantilever applies a second preload to the connecting block. The first preload is smaller than the second preload.

According to some embodiments, when viewed along the first axis, the movable part has an L-shaped structure. The movable part has an upper covering plate and a side covering plate. When viewed along the first axis, the upper covering plate extends along the third axis. When viewed along the first axis, the side covering plate extends along the second axis.

According to some embodiments, the guiding assembly further includes a plurality of first rolling members disposed between the first guiding member and the second guiding member. The first guiding member is movable relative to the second guiding member through the first rolling members. The guiding assembly further includes a plurality of second rolling members disposed between the side covering plate and the base. The movable part is movable relative to the base through the second rolling members.

According to some embodiments, a first groove is formed on the side covering plate and is configured to accommodate the second rolling members. A second groove is formed on the base and is configured to accommodate the second rolling members. When viewed along the first axis, the first groove has a V-shaped structure. When viewed along the first axis, the second groove has a V-shaped structure.

According to some embodiments, the base forms a trench extending along the first axis. The base further has a first top surface, a second top surface and a bottom surface. The trench is formed between the first top surface and the second top surface.

According to some embodiments, the shortest distance between the first top surface and the bottom surface is different from the shortest distance between the second top surface and the bottom surface. The shortest distance between the first top surface and the bottom surface is greater than the shortest distance between the second top surface and the bottom surface.

According to some embodiments, when viewed along the third axis, the first top surface overlaps the first guiding member. The trench has a first surface corresponding to a second surface of the first guiding member. When viewed along the second axis, the first surface overlaps the second surface. The first surface is not in contact with the first guiding member.

According to some embodiments, the driving mechanism further includes a sensing element and a sensed element. The sensing element is disposed on one of the first surface and the second surface. The sensed element is disposed on the other one of the first surface and the second surface.

According to some embodiments, the base further has a first top surface which faces the upper covering plate. The base further has a protrusion extending from the first top surface toward the upper covering plate. A first accommodating groove is formed on the side covering plate. A second accommodating groove is formed on the protrusion.

According to some embodiments, the driving mechanism further includes a sensing element and a sensed element. The sensing element is disposed on either the first accommodating groove or the second accommodating groove. The sensed element is disposed on the other of the first accommodating groove or the second accommodating groove.

According to some embodiments of the disclosure, a driving module includes a first elastic member, a driving member and a piezoelectric assembly. The driving member is fixedly disposed on the first elastic member. The piezoelectric assembly includes a first piezoelectric element and a second piezoelectric element, which are disposed in the first elastic member. The first piezoelectric element and the second piezoelectric element are configured to respectively receive a first control signal and a second control signal to generate deformation to push the first elastic member, so that the first elastic member deforms to drive the driving member to move relative to a base side arm of the first elastic member.

According to some embodiments, the first control signal and the second control signal are AC signals. When the phase difference between the first control signal and the second control signal is 180 degrees, the first piezoelectric element and the second piezoelectric element drive the first elastic member to deform so that the driving member moves back and forth along a first axis.

According to some embodiments, when the phase difference between the first control signal and the second control signal is 0 degrees, the first piezoelectric element and the second piezoelectric element drive the first elastic member to deform so that the driving member moves back and forth along a third axis. The first axis is perpendicular to the third axis.

According to some embodiments, when the phase difference between the first control signal and the second control signal is −90 degrees, the first piezoelectric element and the second piezoelectric element drive the first elastic member to deform so that the driving member rotates clockwise around a second axis. The second axis is perpendicular to the first axis and the third axis.

According to some embodiments, when the phase difference between the first control signal and the second control signal is 90 degrees, the first piezoelectric element and the second piezoelectric element drive the first elastic member to deform so that the driving member rotates counterclockwise around the second axis.

The present disclosure provides a driving mechanism, including a fixed assembly, a movable part and a driving module. The driving module is configured to drive the movable part to move relative to the fixed assembly. The driving module can include a first elastic member, a driving member and two piezoelectric elements. The two piezoelectric elements can be deformed independently to drive the first elastic member to deform correspondingly, so as to drive the driving member to move relative to the fixed assembly.

In some embodiments, when the phase difference of the control signals received by the two piezoelectric elements is −90 degrees, the two piezoelectric elements will drive the first elastic member to deform, so that the driving member continuously rotates clockwise around the second axis. In some embodiments, when the phase difference of the control signals received by the two piezoelectric elements is 90 degrees, the two piezoelectric elements will drive the first elastic member to deform, so that the driving member continuously rotates counterclockwise around the second axis.

Based on this design, the first elastic member and the driving member can quickly drive the movable part to move back and forth along the first axis, and can greatly improve the displacement accuracy compared with the traditional motor. In addition, because the driving mechanism of the present disclosure does not require conventional coils, magnets and additional pushing components, the overall volume of the driving mechanism can be effectively reduced so as to achieve the purpose of miniaturization.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of a driving mechanism 100 according to an embodiment of the present disclosure.

FIG. 2 is an exploded diagram of the driving mechanism 100 according to an embodiment of the present disclosure.

FIG. 3 is a top view of a partial structure of the driving mechanism 100 according to an embodiment of the present disclosure.

FIG. 4 is a front view of the driving mechanism 100 according to an embodiment of the present disclosure.

FIG. 5 is a front view of the driving mechanism 100 according to another embodiment of the present disclosure.

FIG. 6 is a front view of the driving mechanism 100 according to another embodiment of the present disclosure.

FIG. 7 is a top view of a partial structure of the driving mechanism 100 according to an embodiment of the present disclosure.

FIG. 8 to FIG. 10 is a top view illustrating that the first elastic member 104 deforms to drive the driving member 105 to move to be located at different positions according to an embodiment of the present disclosure.

FIG. 11 and FIG. 12 are top views illustrating that the first elastic member 104 drives the driving member 105 to move to be at different positions according to an embodiment of the present disclosure.

FIG. 13 and FIG. 14 are top views illustrating that the first elastic member 104 drives the driving member 105 to move to be at different positions according to an embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

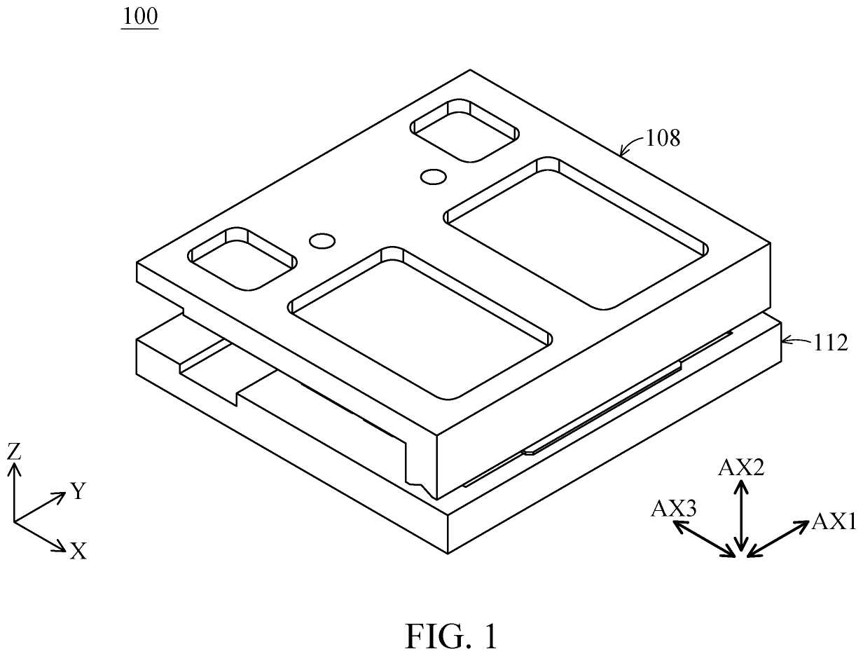

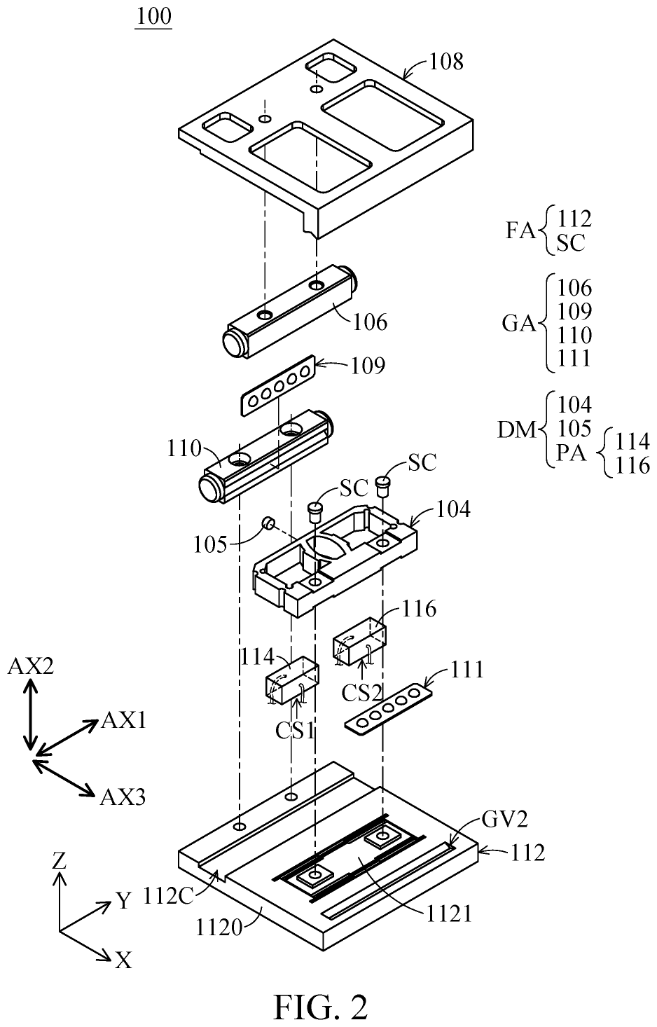

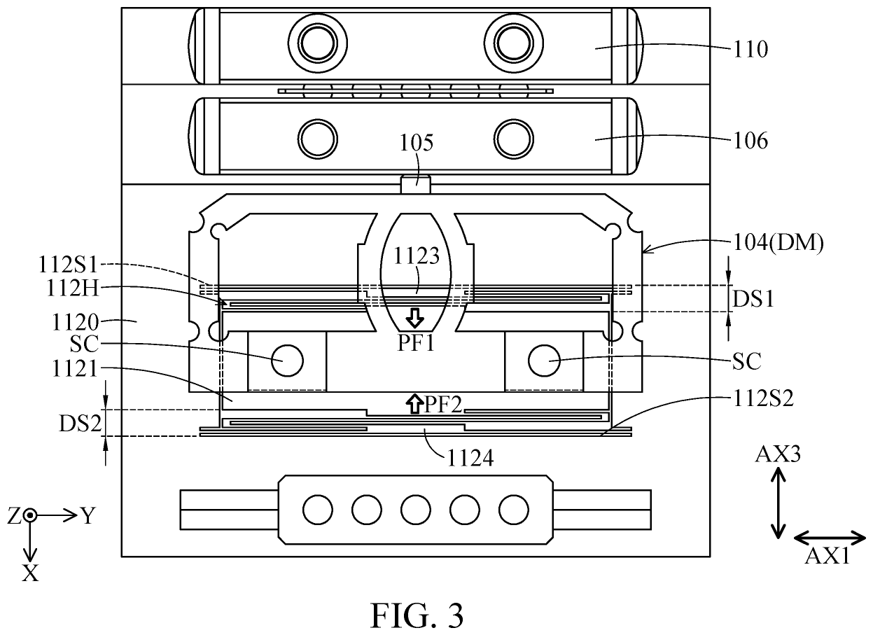

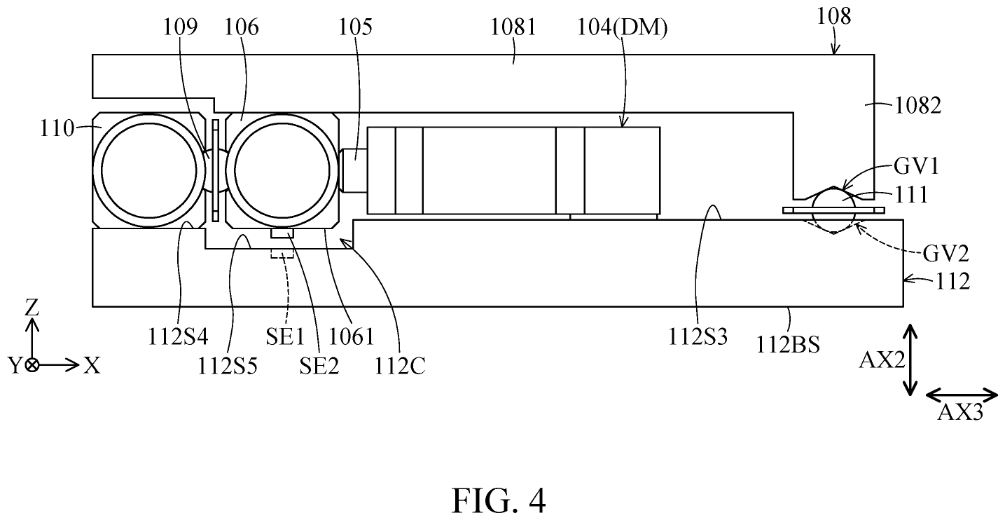

Please refer to FIG. 1 to 4. FIG. 1 is a perspective view of a driving mechanism 100 according to an embodiment of the present disclosure, FIG. 2 is an exploded diagram of the driving mechanism 100 according to an embodiment of the present disclosure, FIG. 3 is a top view of a partial structure of the driving mechanism 100 according to an embodiment of the present disclosure, and FIG. 4 is a front view of the driving mechanism 100 according to an embodiment of the present disclosure. The driving mechanism 100 may be a movable platform configured to drive various elements to move. For example, the driving mechanism 100 can be applied to high-precision instruments such as 3D printers and electron microscopes.

In this embodiment, the driving mechanism 100 may include a fixed assembly FA, a movable part 108 and a driving module DM. The movable part 108 is movable relative to the fixed assembly FA. The driving module DM is configured to drive the movable part 108 to move relative to the fixed assembly FA along a first axis AX1 (the Y-axis). When viewed along the first axis AX1, the driving module DM is located between the fixed assembly FA and the movable part 108 (FIG. 4).

In this embodiment, as shown in FIG. 2, the fixed assembly FA includes a base 112, and the driving module DM is connected to the base 112. For example, the fixed assembly FA may include two locking elements SC configured to connect the driving module DM to the base 112 fixedly. The locking element SC is, for example, a screw, but it is not limited thereto.

Furthermore, the driving mechanism 100 may further include a guiding assembly GA configured to guide the movable part 108 to move relative to the base 112 of the fixed assembly FA along the first axis AX1. The guiding assembly GA may include a first guiding member 106 and a second guiding member 110, the first guiding member 106 can be fixedly connected to the movable part 108 by screws and other components, and the second guiding member 110 can be fixedly connected to the base 112 by screws and other components.

The driving module DM is configured to drive the first guiding member 106 to move relative to the second guiding member 110, so as to drive the movable part 108 to move along the first axis AX1. As shown in FIG. 3, when viewed along a second axis AX2 (the Z-axis), the second guiding member 110, the first guiding member 106 and the driving module DM are arranged in order along a third axis AX3 (the X-axis). The second axis AX2 is perpendicular to the first axis AX1, and the third axis AX3 is perpendicular to the second axis AX2 and the first axis AX1.

As shown in FIG. 3, the base 112 includes a main body 1120 and a connecting block 1121, and the main body 1120 forms an accommodating opening 112H configured to accommodate the connecting block 1121. Furthermore, the base 112 may further include a first cantilever 1123 and a second cantilever 1124, and the connecting block 1121 is connected to the main body 1120 via the first cantilever 1123 and the second cantilever 1124.

When viewed along the second axis AX2, the first cantilever 1123 is connected between a first inner side surface 112S1 of the main body 1120 and the connecting block 1121. When viewed along the second axis AX2, the second cantilever 1124 is connected between a second inner side surface 112S2 of the main body 1120 and the connecting block 1121.

In this embodiment, as shown in FIG. 3 and FIG. 4, the driving module DM may include a first elastic member 104 fixedly installed on the connecting block 1121 through the aforementioned locking elements SC. Furthermore, the driving module DM may further include a driving member 105 which is fixedly disposed on the first elastic member 104.

It is worth noting that when the first elastic member 104 is affixed to the connecting block 1121, the shortest distance DS1 between the connecting block 1121 and the first inner side surface 112S1 is different from the shortest distance DS2 between the connecting block 1121 and the second inner side surface 112S2.

Specifically, the first cantilever 1123 applies a first preload PF1 to the connecting block 1121, the second cantilever 1124 applies a second preload PF2 to the connecting block 1121, and the first preload PF1 is smaller than the second preload PF2.

Therefore, after the first elastic member 104 is affixed to the connecting block 1121, the shortest distance DS1 between the connecting block 1121 and the first inner side surface 112S1 is less than the shortest distance DS2 between the connecting block 1121 and the second inner side surface 112S2.

Based on this design, the first elastic member 104 can drive the driving member 105 to actually contact the first guiding member 106, so as to effectively drive the first guiding member 106 to drive the movable part 108 to move. Therefore, this embodiment does not need additional pushing elements to push the first elastic member 104 and the driving member 105 to achieve the purpose of contacting the first guiding member 106, so that the overall volume of the driving mechanism 100 can be effectively reduced.

As shown in FIG. 4, when viewed along the first axis AX1, the movable part 108 has an L-shaped structure. Specifically, the movable part 108 has an upper covering plate 1081 and a side covering plate 1082, and the upper covering plate 1081 and the side covering plate 1082 can be integrally formed as one piece.

When viewed along the first axis AX1, the upper covering plate 1081 extends along the third axis AX3. When viewed along the first axis AX1, the side covering plate 1082 extends along the second axis AX2.

Moreover, as shown in FIG. 2 and FIG. 4, the guiding assembly GA further includes a plurality of first rolling members 109 disposed between the first guiding member 106 and the second guiding member 110. The first guiding member 106 is movable relative to the second guiding member 110 through these first rolling members 109.

Similarly, the guiding assembly GA may further include a plurality of second rolling members 111 disposed between the side covering plate 1082 and the base 112, so that the movable part 108 is movable relative to the base 112 through these second rolling members 111. The first rolling member 109 and the second rolling member 111 are rolling balls, but they are not limited thereto.

A first groove GV1 can be formed on the side covering plate 1082 and is configured to accommodate these second rolling members 111. Correspondingly, a second groove GV2 can be formed on the base 112 and is configured to accommodate these second rolling members 111. As shown in FIG. 4, when viewed along the first axis AX1, the first groove GV1 has a V-shaped structure, and when viewed along the first axis AX1, the second groove GV2 has a V-shaped structure.

Furthermore, the base 112 may be formed with a trench 112C extending along the first axis AX1. The base 112 further has a first top surface 112S3, a second top surface 112S4 and a bottom surface 112BS. The trench 112C is formed between the first top surface 112S3 and the second top surface 112S4.

As shown in FIG. 4, the shortest distance between the first top surface 112S3 and the bottom surface 112BS along the second axis AX2 is different from the shortest distance between the second top surface 112S4 and the bottom surface 112BS along the second axis AX2. Specifically, the shortest distance between the first top surface 112S3 and the bottom surface 112BS along the second axis AX2 is greater than the shortest distance between the second top surface 112S4 and the bottom surface 112BS along the second axis AX2.

Therefore, when viewed along the third axis AX3, the first top surface 112S3 overlaps the first guiding member 106. Furthermore, the trench 112C has a first surface 112S5 corresponding to a second surface 1061 of the first guiding member 106. When viewed along the second axis AX2, the first surface 112S5 overlaps the second surface 1061, and the first surface 112S5 is not in contact with the first guiding member 106. Based on this structural design, the height of the driving mechanism 100 along the second axis AX2 can be reduced.

In addition, the driving mechanism 100 may further include a sensing element SE1 and a sensed element SE2, the sensing element SE1 is buried under the first surface 112S5, and the sensed element SE2 is disposed on the second surface 1061. The sensing element SE1 is, for example, a Hall sensor, the sensed element SE2 can be a Hall magnet, and the positions of the sensing element SE1 and the sensed element SE2 can be interchanged.

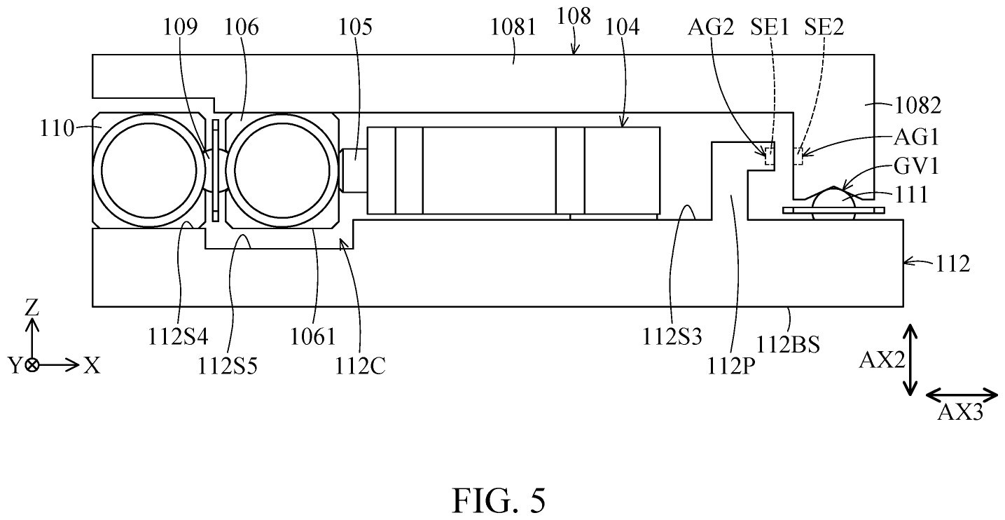

Next, please refer to FIG. 5, which is a front view of the driving mechanism 100 according to another embodiment of the present disclosure. In this embodiment, the first top surface 112S3 faces the upper covering plate 1081, and the base 112 further has a protrusion 112P which extends from the first top surface 112S3 toward the upper covering plate 1081. The protrusion 112P and the base 112 can be integrally formed as one piece, and when viewed along the first axis AX1, the protrusion 112P has an L-shaped structure.

A first accommodating groove AG1 may be formed on the side covering plate 1082, and a second accommodating groove AG2 may be formed on the protrusion 112P. The sensing element SE1 is disposed on one of the first accommodating groove AG1 and the second accommodating groove AG2, and the sensed element SE2 is disposed on the other one of the first accommodating groove AG1 and the second accommodating groove AG2.

Based on such a structural design, the space between the movable part 108 and the base 112 can be effectively utilized, and the sensing accuracy of the sensing element SE1 can be increased at the same time.

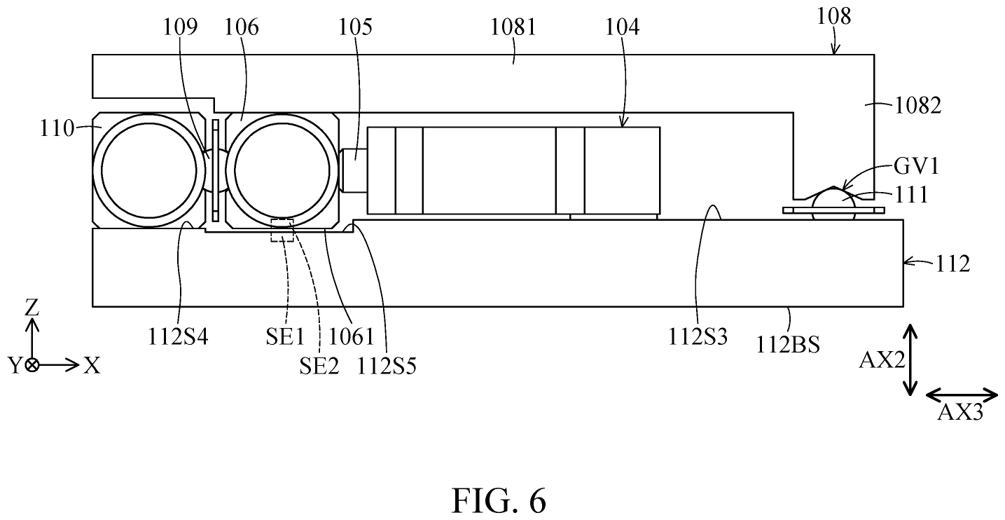

Please refer to FIG. 6, which is a front view of the driving mechanism 100 according to another embodiment of the present disclosure. In this embodiment, the distance between the first surface 112S5 and the second surface 1061 is further reduced, so that not only the sensing accuracy of the sensing element SE1 can be increased, but also the overall structural strength of the base 112 can be increased.

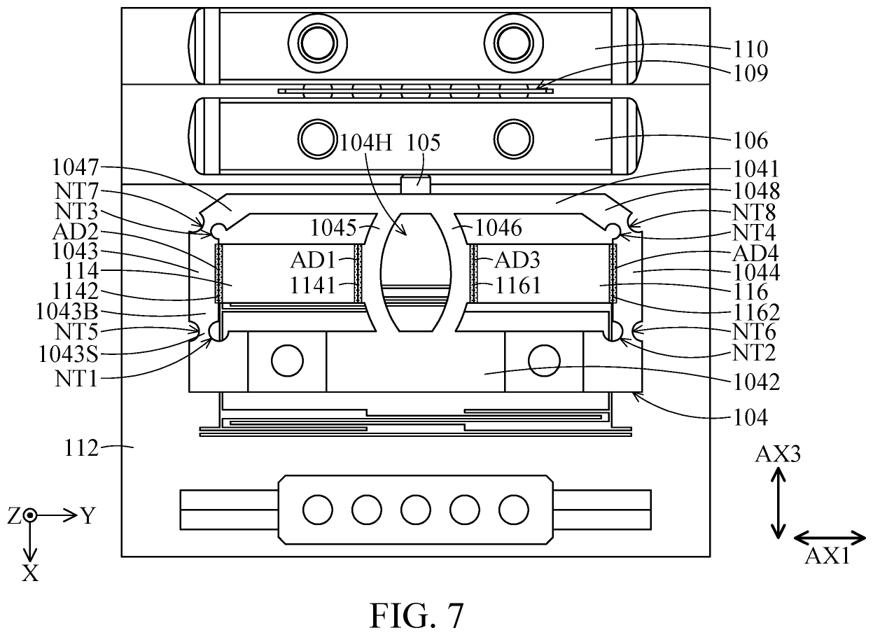

Please refer to FIG. 7. FIG. 7 is a top view of a partial structure of the driving mechanism 100 according to an embodiment of the present disclosure. In this embodiment, the first elastic member 104 is made of a first metal material. For example, the first metal material may include stainless steel. Furthermore, the driving member 105 can be made of a second metal material, and the second metal material can include tool steel, for example. The materials of the first elastic member 104 and the driving member 105 are not limited to this embodiment.

It should be noted that the rigidity of the driving member 105 is greater than that of the first elastic member 104. That is, when the first elastic member 104 deforms, the driving member 105 will not deform accordingly. Furthermore, the driving member 105 may have a cylindrical structure, but the shape of the driving member 105 is not limited thereto. As long as it can contact and drive the first guiding member 106, the shaped is within the scope of the present disclosure.

The driving module DM may further include a piezoelectric assembly PA configured to drive the first elastic member 104 to deform so as to drive the driving member 105 to move relative to the fixed assembly FA. Therefore, the driving member 105 can drive the movable part 108 to move along the first axis AX1 relative to the fixed assembly FA.

As shown in FIG. 7, when viewed along the second axis AX2, the first elastic member 104 may have a rectangular structure. Specifically, the first elastic member 104 has a first side arm 1041 and a second side arm 1042, the first side arm 1041 and the second side arm 1042 extend along the first axis AX1, and the driving member 105 can be fixedly disposed on the first side arm 1041 by using glue.

The first elastic member 104 may further have a third side arm 1043 and a fourth side arm 1044 which are connected between the first side arm 1041 and the second side arm 1042, and the third side arm 1043 and the fourth side arm 1044 extends along the third axis AX3.

Furthermore, the first elastic member 104 may further have a first inner arm 1045 and a second inner arm 1046. The first inner arm 1045 and the second inner arm 1046 are connected between the first side arm 1041 and the second side arm 1042, and the first side arm 1041, the second side arm 1042, the third side arm 1043, the fourth side arm 1044, the first inner arm 1045 and the second inner arm 1046 are integrally formed as one piece.

In this embodiment, the first inner arm 1045 is bent toward the third side arm 1043, and the second inner arm 1046 is bent toward the fourth side arm 1044. As shown in FIG. 7, a central hole 104H is formed between the first inner arm 1045 and the second inner arm 1046, and the central hole 104H has an elliptical structure.

In this embodiment, the piezoelectric assembly PA includes a first piezoelectric element 114 and a second piezoelectric element 116, which are disposed in the first elastic member 104. The first piezoelectric element 114 and the second piezoelectric element 116 are, for example, piezoelectric ceramics, but they are not limited thereto.

Specifically, the first piezoelectric element 114 is connected between the third side arm 1043 and the first inner arm 1045, and when viewed along the second axis AX2, the first piezoelectric element 114 has a rectangular cuboid structure.

The first piezoelectric element 114 may have a first top surface 1141, which is fixedly connected to the first inner arm 1045 by a first adhesive element AD1. The first top surface 1141 may have four sides (FIG. 2), and the first adhesive element AD1 is disposed on the four sides.

Similarly, the first piezoelectric element 114 has a first bottom surface 1142, which is fixedly connected to the third side arm 1043 by a second adhesive element AD2. The first bottom surface 1142 may have four sides, and the second adhesive element AD2 is disposed on the four sides. It should be noted that the first top surface 1141 and the first bottom surface 1142 are non-conductive.

Similarly, the second piezoelectric element 116 is connected between the fourth side arm 1044 and the second inner arm 1046, and when viewed along the second axis AX2, the second piezoelectric element 116 has a rectangular cuboid structure.

The second piezoelectric element 116 may have a second top surface 1161, which is fixedly connected to the second inner arm 1046 by a third adhesive element AD3. The second top surface 1161 may have four sides (FIG. 2), and the third adhesive element AD3 is disposed on the four sides.

Similarly, the second piezoelectric element 116 has a second bottom surface 1162, which is fixedly connected to the fourth side arm 1044 by a fourth adhesive element AD4. The second bottom surface 1162 may have four sides, and the fourth adhesive element AD4 is disposed on the four sides. The second top surface 1161 and the second bottom surface 1162 are non-conductive.

As shown in FIG. 7, when the first elastic member 104 is not deformed (the initial state), and when viewed along the second axis AX2, the third side arm 1043, the first piezoelectric element 114, the first The inner arm 1045 are symmetrical to the fourth side arm 1044, the second piezoelectric element 116 and the second inner arm 1046.

In this embodiment, a plurality of notches can be formed on the first elastic member 104. These notches may include a first notch NT1 formed between the second side arm 1042 and the third side arm 1043. These notches may further include a second notch NT2 formed between the second side arm 1042 and the fourth side arm 1044, and the first notch NT1 is symmetrical to the second notch NT2.

Furthermore, these notches may further include a third notch NT3 formed between the first side arm 1041 and the third side arm 1043. These notches may further include a fourth notch NT4 formed between the first side arm 1041 and the fourth side arm 1044, and the third notch NT3 is symmetrical to the fourth notch NT4. As shown in FIG. 7, the first notch NT1 to the fourth notch NT4 each have a circular arc structure.

In addition, in order to increase the amount of deformation of the first elastic member 104, in this embodiment, these notches may further include a fifth notch NT5 formed between the second side arm 1042 and the third side arm 1043. These notches may further include a sixth notch NT6 formed between the second side arm 1042 and the fourth side arm 1044, and the fifth notch NT5 is symmetrical to the sixth notch NT6.

In this embodiment, the first notch NT1 and the fifth notch NT5 are formed on opposite sides of the third side arm 1043, and the second notch NT2 and the sixth notch NT6 are formed on opposite sides of the fourth side arm 1044.

Similarly, the notches may further include a seventh notch NT7 formed between the first side arm 1041 and the third side arm 1043. These notches may further include an eighth notch NT8 formed between the first side arm 1041 and the fourth side arm 1044, and the seventh notch NT7 is symmetrical to the eighth notch NT.

The third notch NT3 and the seventh notch NT7 are formed on opposite sides of the third side arm 1043, and the fourth notch NT4 and the eighth notch NT8 are formed on opposite sides of the fourth side arm 1044.

As shown in FIG. 7, the third side arm 1043 may have a thick column portion 1043B and a thin column portion 1043S, and the thin column portion 1043S is formed between the first notch NT1 and the fifth notch NT5. In this embodiment, the width of the thick column portion 1043B along the first axis AX1 is at least twice the width of the thin column portion 1043S along the first axis AX1.

Based on the design of the above notches and side arms, the first elastic member 104 can be effectively deformed to drive the driving member 105. Furthermore, the number of the above notches is not limited to this embodiment. For example, in some embodiments, the first elastic member 104 may only include the first to fourth notch NT1 to NT4.

In addition, in this embodiment, the first elastic member 104 may further have a first bevel arm 1047 connected between the first side arm 1041 and the third side arm 1043. The first bevel arm 1047 is not parallel to the first axis AX1 and the third axis AX3, and the third notch NT3 and the seventh notch NT7 can be formed on the first bevel arm 1047.

Similarly, the first elastic member 104 may further have a second bevel arm 1048 connected between the first side arm 1041 and the fourth side arm 1044. The second bevel arm 1048 is not parallel to the first axis AX1 and the third axis AX3, and the fourth notch NT4 and the eighth notch NT8 can be formed on the second bevel arm 1048.

Based on the above-mentioned design of the first bevel arm 1047 and the second bevel arm 1048, the first elastic member 104 can be further rapidly deformed, thereby driving the driving member 105 to move.

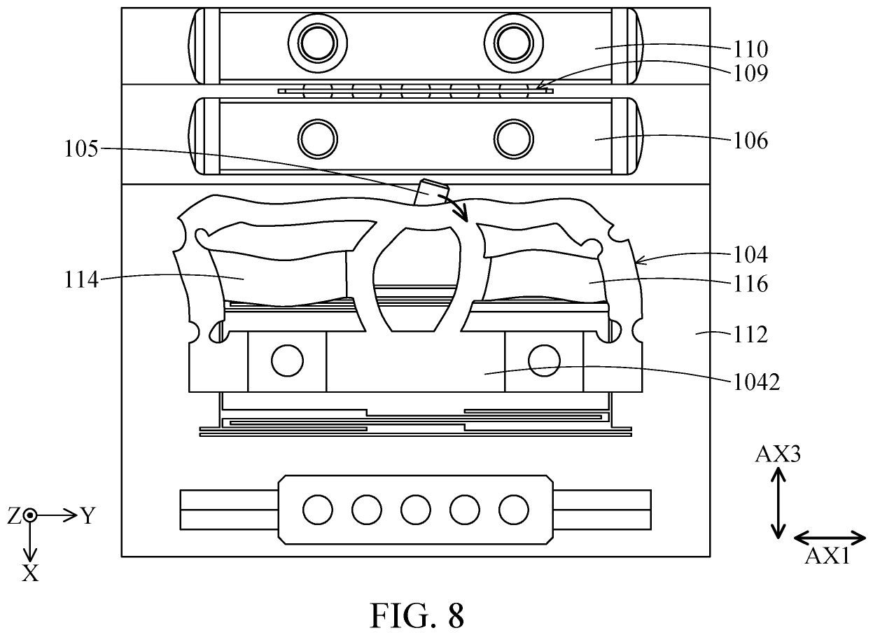

Next, please refer to FIG. 7 to FIG. 10. FIG. 8 to FIG. 10 is a top view illustrating that the first elastic member 104 deforms to drive the driving member 105 to move to be located at different positions according to an embodiment of the present disclosure. In this embodiment, the first piezoelectric element 114 and the second piezoelectric element 116 are configured to respectively receive a first control signal CS1 and a second control signal CS2 (FIG. 2) from an external control circuit via the leading wires to generate deformation.

After receiving the above control signals, the first piezoelectric element 114 and the second piezoelectric element 116 will deform according to the first control signal CS1 and the second control signal CS2 to push the first elastic member 104, so that the first elastic member 104 deforms to drive the driving member 105 to move relative to a base side arm (the second side arm 1042) of the first elastic member 104. That is, the base side arm (the second side arm 1042) does not deform.

The first control signal CS1 may be different from the second control signal CS2. That is, the external control circuit may independently control the first piezoelectric element 114 and the second piezoelectric element 116. Furthermore, the first control signal CS1 and the second control signal CS2 can be AC signals. For example, the first control signal CS1 can be a sine wave signal, and the second control signal CS2 can be a cosine wave signal, but they are not limited thereto.

It is worth noting that the frequency of the first control signal CS1 and the second control signal CS2 is equal to the overall resonance frequency of the first elastic element 104, the first piezoelectric element 114 and the second piezoelectric element 116. Such design can facilitate the first elastic member 104 to deform easily.

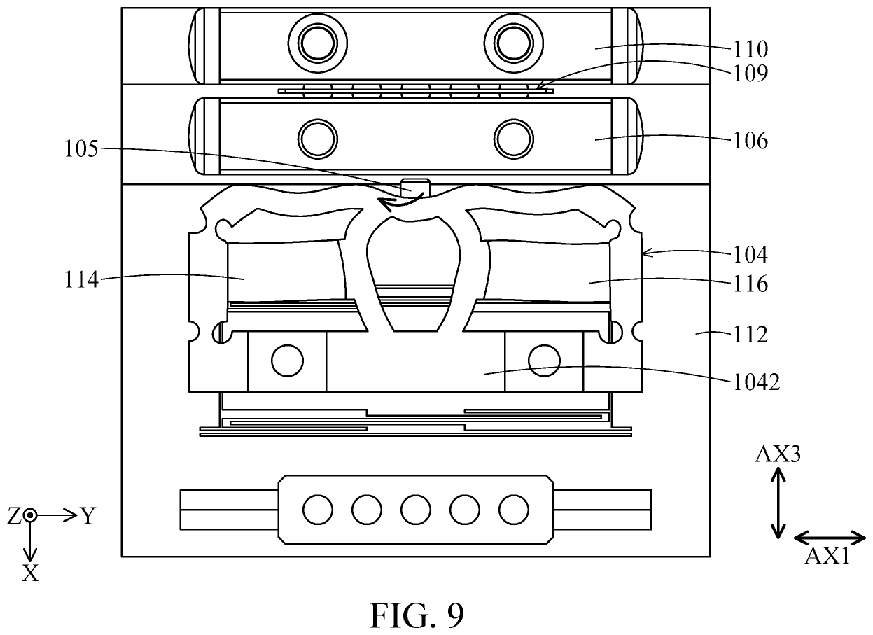

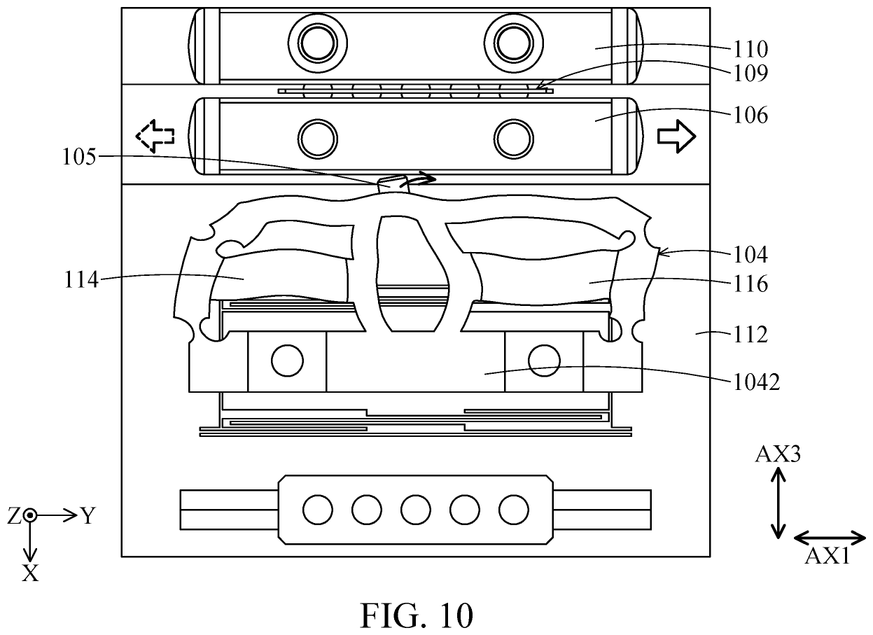

As shown in FIG. 7 to FIG. 10, when the phase difference between the first control signal CS1 and the second control signal CS2 is −90 degrees, the first piezoelectric element 114 will first expand and the second piezoelectric element 116 will contract first, to drive the first elastic member 104 to deform, so that the driving member 105 rotates from the position in FIG. 7 to the positions in FIG. 8, FIG. 9 and FIG. 10 in sequence, and then return to the position of FIG. 7.

That is, the driving member 105 can continuously rotate clockwise around the second axis AX2 (the Z-axis), and the trajectory of the driving member 105 is an ellipse. Therefore, as shown in FIG. 10, the driving member 105 pushes the first guiding member 106 to move rightward along the first axis AX1 to drive the movable part 108 to move rightward relative to the base 112.

Conversely, when the phase difference between the first control signal CS1 and the second control signal CS2 is 90 degrees, the first piezoelectric element 114 and the second piezoelectric element 116 drive the first elastic member 104 to deform, so that the driving member 105 rotates from the position in FIG. 7 to the positions in FIG. 10, FIG. 9, and FIG. 8 in sequence, and then returns to the position in FIG. 7.

That is, the driving member 105 can continuously rotate counterclockwise around the second axis AX2 (the Z-axis), and the trajectory of the driving member 105 is an ellipse. Therefore, as shown in FIG. 10, the driving member 105 pushes the first guiding member 106 to move leftward along the first axis AX1 to drive the movable part 108 to move leftward relative to the base 112.

It is worth noting that, in the present disclosure, the displacement of the driving member 105 is greater than the deformation of the first piezoelectric element 114 or the second piezoelectric element 116. That is, based on the design of the present disclosure, the small deformation of the piezoelectric elements can be transformed into a larger displacement of the driving member 105, thereby achieving the purpose of miniaturization.

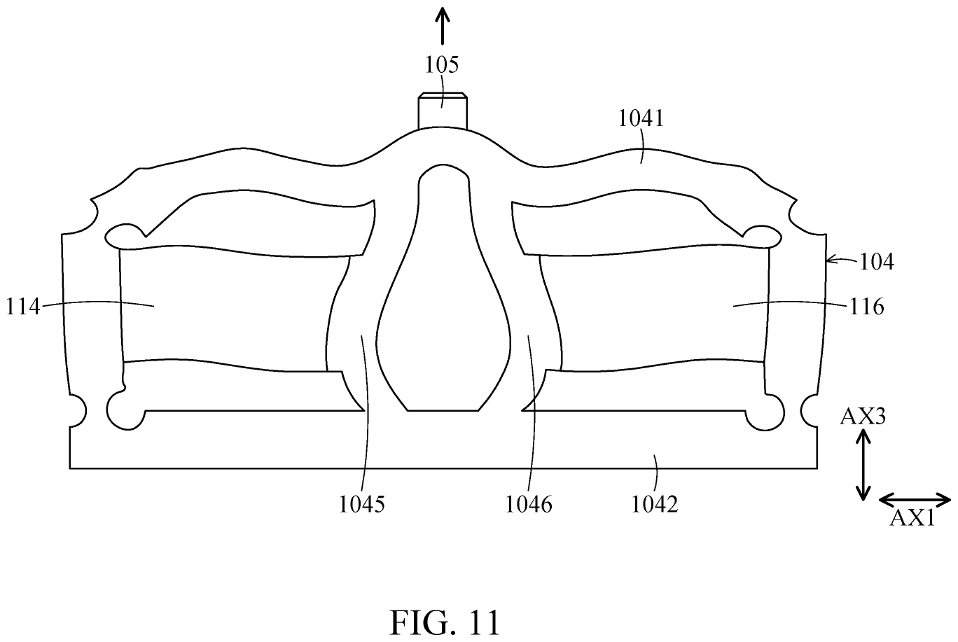

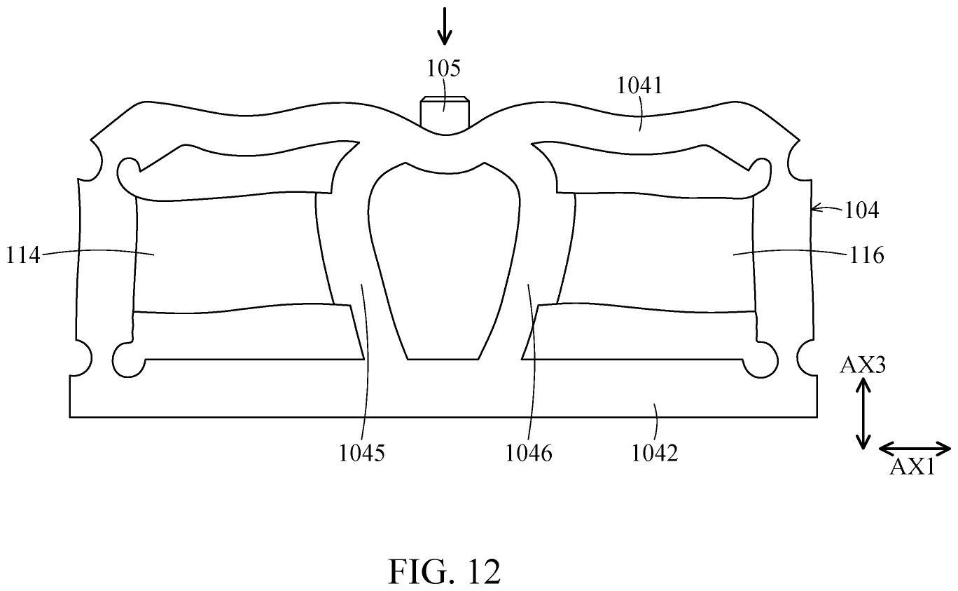

Next, please refer to FIG. 7, FIG. 11 and FIG. 12. FIG. 11 and FIG. 12 are top views illustrating that the first elastic member 104 drives the driving member 105 to move to be at different positions according to an embodiment of the present disclosure. In this embodiment, when the phase difference between the first control signal CS1 and the second control signal CS2 is 0 degrees, the first piezoelectric element 114 and the second piezoelectric element 116 will first expand at the same time, so that the first elastic element 104 deforms from an initial state in FIG. 7 to the a deformation state shown in FIG. 11.

Next, the first piezoelectric element 114 and the second piezoelectric element 116 contract at the same time, so that the first elastic member 104 changes from the first deformation state shown in FIG. 11 to a second deformation state shown in FIG. 12. Because the first elastic member 104 repeatedly switches between the first deformation state and the second deformation state, the first elastic member 104 can drive the driving member 105 to move back and forth along the third axis AX3. Based on the driving method, the driving module DM can drive an object to move back and forth along the third axis AX3.

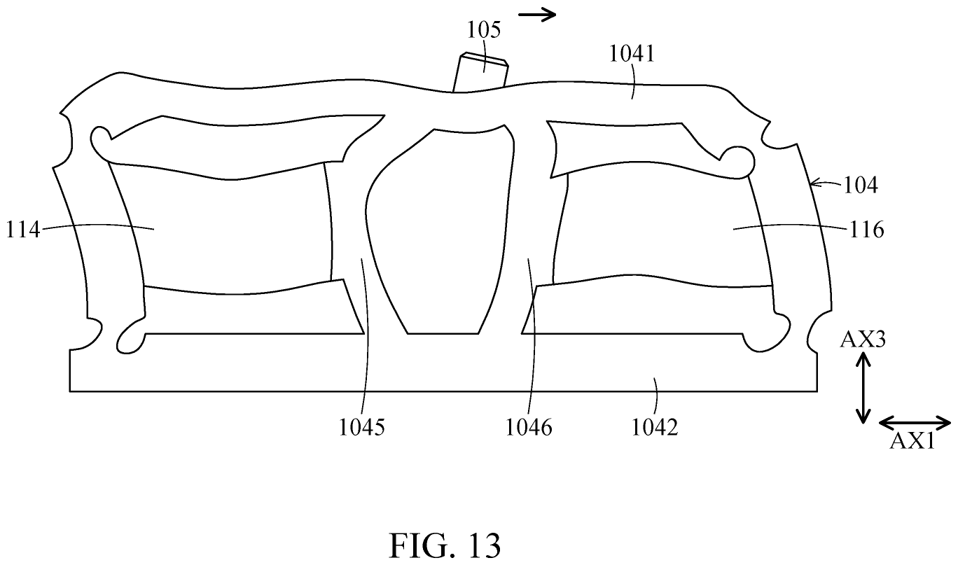

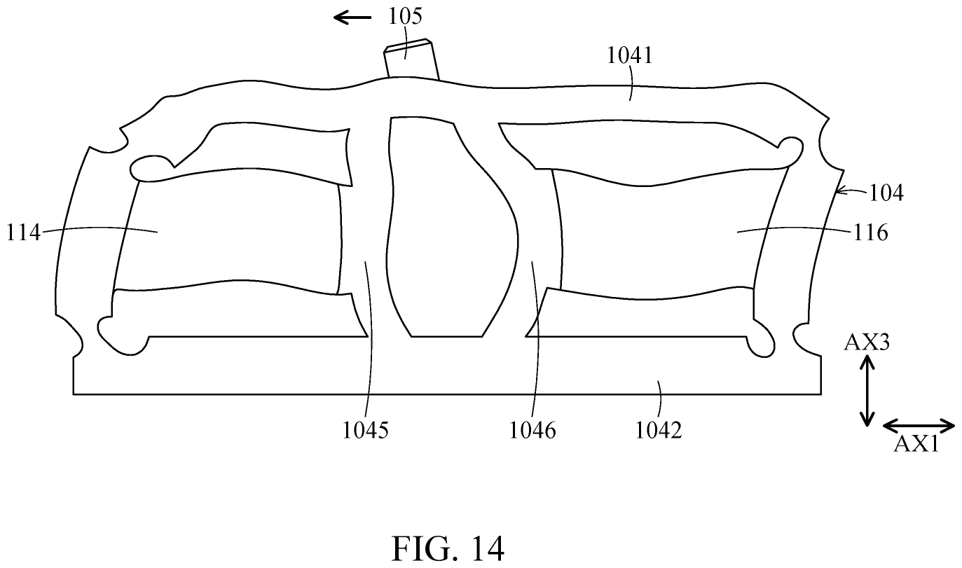

Next, please refer to FIG. 7, FIG. 13 and FIG. 14. FIG. 13 and FIG. 14 are top views illustrating that the first elastic member 104 drives the driving member 105 to move to be at different positions according to an embodiment of the present disclosure. In this embodiment, when the phase difference between the first control signal CS1 and the second control signal CS2 is 180 degrees, the first piezoelectric element 114 will contract first and the second piezoelectric element 116 will expand first, so that the first elastic member 104 deforms from the initial state in FIG. 7 to the third deformation state in FIG. 13.

Then, the first piezoelectric element 114 starts to expand and the second piezoelectric element 116 starts to contract, so that the first elastic member 104 changes from the third deformation state in FIG. 13 to a fourth deformation state in FIG. 14. Because the first elastic member 104 repeatedly switches between the third deformation state and the fourth deformation state, the first elastic member 104 can drive the driving member 105 to move back and forth along the first axis AX1.

Based on the driving method, the driving module DM can quickly touch or provide vibration to an object. For example, the driving module DM can provide vibration to the liquid so as to achieve the function of ultrasonic cleaning.

In conclusion, the present disclosure provides a driving mechanism, including a fixed assembly, a movable part and a driving module. The driving module is configured to drive the movable part to move relative to the fixed assembly. The driving module can include a first elastic member, a driving member and two piezoelectric elements. The two piezoelectric elements can be deformed independently to drive the first elastic member to deform correspondingly, so as to drive the driving member to move relative to the fixed assembly.

In some embodiments, when the phase difference of the control signals received by the two piezoelectric elements is −90 degrees, the two piezoelectric elements will drive the first elastic member 104 to deform, so that the driving member 105 continuously rotates clockwise around the second axis AX2. In some embodiments, when the phase difference of the control signals received by the two piezoelectric elements is 90 degrees, the two piezoelectric elements will drive the first elastic member 104 to deform, so that the driving member 105 continuously rotates counterclockwise around the second axis AX2.

Based on this design, the first elastic member 104 and the driving member 105 can quickly drive the movable part 108 to move back and forth along the first axis AX1, and can greatly improve the displacement accuracy compared with the traditional motor. In addition, because the driving mechanism 100 of the present disclosure does not require conventional coils, magnets and additional pushing components, the overall volume of the driving mechanism 100 can be effectively reduced so as to achieve the purpose of miniaturization.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A driving mechanism, comprising:
a fixed assembly;
a movable part, configured to move relative to the fixed assembly; and
a driving module, configured to drive the movable part to move relative to the fixed assembly;
wherein when viewed along a first axis, the driving module is disposed between the fixed assembly and the movable part.

2. The driving mechanism as claimed in claim 1, wherein
the fixed assembly includes a base;
the driving mechanism further includes a guiding assembly;
the guiding assembly is configured to guide the movable part to move along the first axis relative to the fixed assembly;
the driving module is connected to the base;
the guiding assembly includes a first guiding member and a second guiding member;
the first guiding member is fixedly connected to the movable part;
the second guiding member is fixedly connected to the base;
the driving module is configured to drive the first guiding member to move relative to the second guiding member, so as to drive the movable part to move along the first axis.

3. The driving mechanism as claimed in claim 2, wherein
when viewed along a second axis, the second guiding member, the first guiding member and the driving module are arranged in sequence along a third axis;
the second axis is perpendicular to the first axis;
the third axis is perpendicular to the second axis and the first axis.

4. The driving mechanism as claimed in claim 3, wherein
the base includes a main body and a connecting block;
the main body forms an accommodating opening configured to accommodate the connecting block;
the base further includes a first cantilever and a second cantilever;
the connecting block is connected to the main body via the first cantilever and the second cantilever;
when viewed along the second axis, the first cantilever is connected between a first inner side surface of the main body and the connecting block;
when viewed along the second axis, the second cantilever is connected between a second inner side surface of the main body and the connecting block.

5. The driving mechanism as claimed in claim 4, wherein
the driving module includes a first elastic member fixedly installed on the connecting block;
when the first elastic member is affixed to the connecting block, a shortest distance between the connecting block and the first inner side surface is different from a shortest distance between the connecting block and the second inner side surface.

6. The driving mechanism as claimed in claim 5, wherein
when the first elastic member is affixed to the connecting block, the shortest distance between the connecting block and the first inner side surface is less than the shortest distance between the connecting block and the second inner side surface;
the first cantilever applies a first preload to the connecting block;
the second cantilever applies a second preload to the connecting block;
the first preload is smaller than the second preload.

7. The driving mechanism as claimed in claim 3, wherein
when viewed along the first axis, the movable part has an L-shaped structure;
the movable part has an upper covering plate and a side covering plate;
when viewed along the first axis, the upper covering plate extends along the third axis;
when viewed along the first axis, the side covering plate extends along the second axis.

8. The driving mechanism as claimed in claim 7, wherein
the guiding assembly further includes a plurality of first rolling members disposed between the first guiding member and the second guiding member;
the first guiding member is movable relative to the second guiding member through the first rolling members;
the guiding assembly further includes a plurality of second rolling members disposed between the side covering plate and the base;
the movable part is movable relative to the base through the second rolling members.

9. The driving mechanism as claimed in claim 8, wherein
a first groove is formed on the side covering plate and is configured to accommodate the second rolling members;
a second groove is formed on the base and is configured to accommodate the second rolling members;
when viewed along the first axis, the first groove has a V-shaped structure;
when viewed along the first axis, the second groove has a V-shaped structure.

10. The driving mechanism as claimed in claim 9, wherein
the base forms a trench extending along the first axis;
the base further has a first top surface, a second top surface and a bottom surface;
the trench is formed between the first top surface and the second top surface.

11. The driving mechanism as claimed in claim 10, wherein
a shortest distance between the first top surface and the bottom surface is different from a shortest distance between the second top surface and the bottom surface;
the shortest distance between the first top surface and the bottom surface is greater than the shortest distance between the second top surface and the bottom surface.

12. The driving mechanism as claimed in claim 11, wherein
when viewed along the third axis, the first top surface overlaps the first guiding member;
the trench has a first surface corresponding to a second surface of the first guiding member;
when viewed along the second axis, the first surface overlaps the second surface;
the first surface is not in contact with the first guiding member.

13. The driving mechanism as claimed in claim 12, wherein
the driving mechanism further includes a sensing element and a sensed element;
the sensing element is disposed on one of the first surface and the second surface;
the sensed element is disposed on the other one of the first surface and the second surface.

14. The driving mechanism as claimed in claim 9, wherein
the base further has a first top surface which faces the upper covering plate;
the base further has a protrusion extending from the first top surface toward the upper covering plate;
a first accommodating groove is formed on the side covering plate;
a second accommodating groove is formed on the protrusion.

15. The driving mechanism as claimed in claim 14, wherein
the driving mechanism further includes a sensing element and a sensed element;
the sensing element is disposed on one of the first accommodating groove and the second accommodating groove;
the sensed element is disposed on the other one of the first accommodating groove and the second accommodating groove.

16. A driving module, comprising:
a first elastic member;
a driving member, fixedly disposed on the first elastic member; and
a piezoelectric assembly, including a first piezoelectric element and a second piezoelectric element, which are disposed in the first elastic member;
wherein the first piezoelectric element and the second piezoelectric element are configured to respectively receive a first control signal and a second control signal to generate deformation to push the first elastic member, so that the first elastic member deforms to drive the driving member to move relative to a base side arm of the first elastic member.

17. The driving module as claimed in claim 16, wherein
the first control signal and the second control signal are AC signals; and
when the phase difference between the first control signal and the second control signal is 180 degrees, the first piezoelectric element and the second piezoelectric element drive the first elastic member to deform so that the driving member moves back and forth along a first axis.

18. The driving module as claimed in claim 17, wherein
when the phase difference between the first control signal and the second control signal is 0 degrees, the first piezoelectric element and the second piezoelectric element drive the first elastic member to deform so that the driving member moves back and forth along a third axis; and
the first axis is perpendicular to the third axis.

19. The driving module as claimed in claim 18, wherein
when the phase difference between the first control signal and the second control signal is −90 degrees, the first piezoelectric element and the second piezoelectric element drive the first elastic member to deform so that the driving member rotates clockwise around a second axis; and
The second axis is perpendicular to the first axis and the third axis.

20. The driving module as claimed in claim 19, wherein
when the phase difference between the first control signal and the second control signal is 90 degrees, the first piezoelectric element and the second piezoelectric element drive the first elastic member to deform so that the driving member rotates counterclockwise around the second axis.
